(19) United States
(12) Patent Application Publication
(10) Pub. No.: US 2026/0034587 A1
(43) Pub. Date: Feb. 5, 2026

(54) CUTTING TOOL, AND METHOD FOR MANUFACTURING MACHINED PRODUCT

(71) Applicant: KYOCERA CORPORATION, Kyoto (JP)

(72) Inventor: Shigetaka HASHIMOTO, Kyoto (JP)

(21) Appl. No.: 18/995,148

(22) PCT Filed: Jul. 14, 2023
(86) PCT No.: PCT/JP2023/026101

§ 371 Date: Jan. 16, 2025

(30) Foreign Application Priority Data
Jul. 25, 2022 (JP) 2022-118230

(51) Int. Cl. B23B 29/12

(52) U.S. Cl. CPC B23B 29/12; B23B 2260/072; B23B 2260/128

(57) ABSTRACT

A cutting tool comprises a holder, a cutting insert, a sensor and a wiring member. The holder has a rod shape and comprises a front end surface, an upper surface, a lower surface, a first side surface, a second side surface and a pocket. A cutting insert is located in the pocket and comprises a cutting edge. The sensor is located on the outer surface on the side of the front end of the holder. The wiring member is electrically connected to the sensor and extends from the side of the sensor toward the rear end of the holder. The holder includes a groove that is open to both the lower surface and the second side surface and extends from the side of the front end toward the rear end. The wiring member is located in the groove.

### TECHNICAL FIELD

The present disclosure relates to a cutting tool used in machining of a workpiece, and a method for manufacturing a machined product.

### BACKGROUND OF INVENTION

For example, a cutting tool described in Patent Document 1 is known as a cutting tool used in machining of a workpiece for manufacturing a machined product. The cutting tool described in Patent Document 1 includes a rod-shaped holder (referred to as a body portion in Patent Document 1), a sensor portion for detecting a physical quantity (referred to as physical information in Patent Document 1) of a cutting insert (referred to as a cutting edge in Patent Document 1), and a wiring member (referred to as a cable member in Patent Document 1) electrically connected to the sensor portion. In the cutting tool described in Patent Document 1, the wiring member is incorporated in the holder.

### CITATION LIST

### Patent Literature

Patent Document 1: JP 2012-020359 A

### SUMMARY

A cutting tool according to the present disclosure includes a holder, a cutting insert, a sensor, and a wiring member. The holder has a rod shape extending from a front end toward a rear end and includes a front end surface located on a side of the front end, an upper surface extending from the front end surface toward the rear end, a lower surface located on an opposite side to the upper surface, a first side surface located between the upper surface and the lower surface and extending from the front end surface toward the rear end, a second side surface located on an opposite side to the first side surface, and a pocket open to the front end surface, the upper surface, and the first side surface. The cutting insert is located in the pocket and includes a cutting edge. The sensor is located on an outer surface of the holder on a side of the front end and configured to detect a physical quantity of the holder. The wiring member is electrically connected to the sensor and extends from a side of the sensor toward the rear end. The holder further includes a groove that is open to both the lower surface and the second side surface and extends from the side of the front end toward the rear end. The wiring member is located in the groove.

### BRIEF DESCRIPTION OF THE DRAWINGS

FIG. 1 is a schematic perspective view of a cutting tool according to an embodiment of the present disclosure.

FIG. 2 is a schematic perspective view of the cutting tool illustrated in FIG. 1 viewed at a different angle.

FIG. 3 is a schematic plan view of the cutting tool illustrated in FIG. 1.

FIG. 4 is a schematic view of the cutting tool illustrated in FIG. 1, as viewed from a front end side of the cutting tool.

FIG. 5 is a schematic side view of the cutting tool illustrated in FIG. 1.

FIG. 6 is an enlarged schematic view of another side surface of the cutting tool illustrated in FIG. 5.

FIG. 7 is a cross-sectional view taken along line VII-VII in FIG. 5.

FIG. 8 is a cross-sectional view taken along line VIII-VIII in FIG. 5.

FIG. 9 is a cross-sectional view taken along line IX-IX in FIG. 5.

FIG. 10 is an enlarged view of a portion X in FIG. 8, and is an enlarged cross-sectional view illustrating a groove of a holder and a wiring member.

FIG. 11 is an enlarged cross-sectional view illustrating a groove of a holder and a wiring member in a cutting tool according to another aspect of the embodiment of the present disclosure.

FIG. 12 is an enlarged cross-sectional view illustrating a groove of a holder and a wiring member in a cutting tool according to another aspect of the embodiment of the present disclosure.

FIG. 13 is an enlarged cross-sectional view illustrating a groove of a holder and a wiring member in a cutting tool according to another aspect of the embodiment of the present disclosure.

FIG. 14 is a schematic view illustrating a method for manufacturing a machined product according to an embodiment of the present disclosure.

FIG. 15 is a schematic view illustrating the method for manufacturing the machined product according to the embodiment of the present disclosure.

FIG. 16 is a schematic view illustrating the method for manufacturing the machined product according to the embodiment of the present disclosure.

### DESCRIPTION OF EMBODIMENTS

In the cutting tool described in Patent Document 1, in order to house the wiring member in the holder, a through hole for housing the wiring member in the holder needs to be formed. However, forming an elongated through hole along the central axis of the rod-shaped holder is not easy, and an increase in the manufacturing cost of the cutting tool is a concern. In other words, when the cutting tool described in Patent Literature 1 includes the sensor portion, an increase in the manufacturing cost of the cutting tool is a concern.

According to the present disclosure, the likelihood of an increase in the manufacturing cost of a cutting tool can be reduced even when the cutting tool includes a sensor.

A cutting tool, and a method for manufacturing a machined product according to an embodiment of the present disclosure will be described below in detail with reference to the drawings. However, each of the drawings, which will be referred to below, is a simplified representation of only components necessary for description of the embodiment, for convenience of description. Accordingly, the cutting insert according to an embodiment of the present disclosure may be provided with an optional component that is not illustrated in the referenced drawings. The dimensions of the components in the drawings do not faithfully represent the actual dimensions of the components, the dimension ratios of the members, or the like.

In the present disclosure, description will be made based on an orthogonal coordinate system XYZ defined by three directions orthogonal to each other. The X direction is a front-rear direction, one side in the X direction is a front side or a front direction, and the other side in the X direction is a rear side or a rear direction. The Y direction is a left-right direction, one side in the Y direction is a left side or a left direction, and the other side in the Y direction is a right side or a right direction. The Z direction is a vertical direction, one side in the Z direction is an upper side or an upward direction, and the other side in the Z direction is a lower side or a downward direction. The XY direction refers to two directions of the X direction and the Y direction, the XZ direction refers to two directions of the X direction and the Z direction, and the YZ direction refers to two directions of the Y direction and the Z direction. The XYZ direction refers to three directions of the X direction, the Y direction, and the Z direction.

In the drawings, “FF” indicates the front direction, “FR” indicates the rear direction, “L” indicates the left direction, “R” indicates the right direction, “U” indicates the upward direction, and “D” indicates the downward direction.

### Cutting Tool

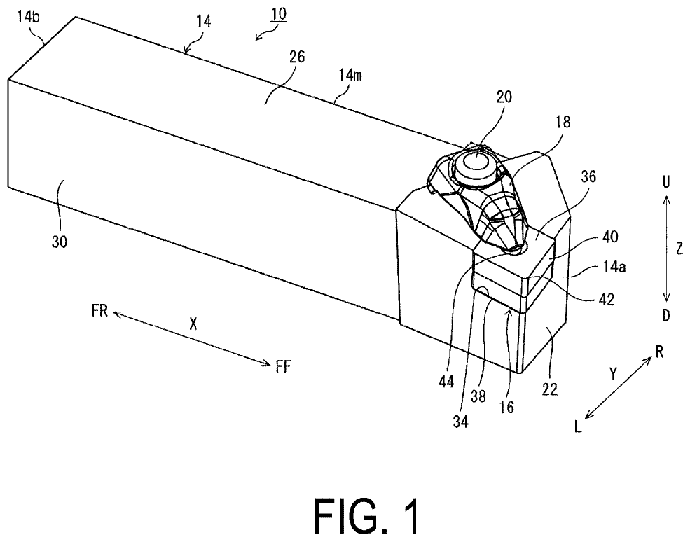

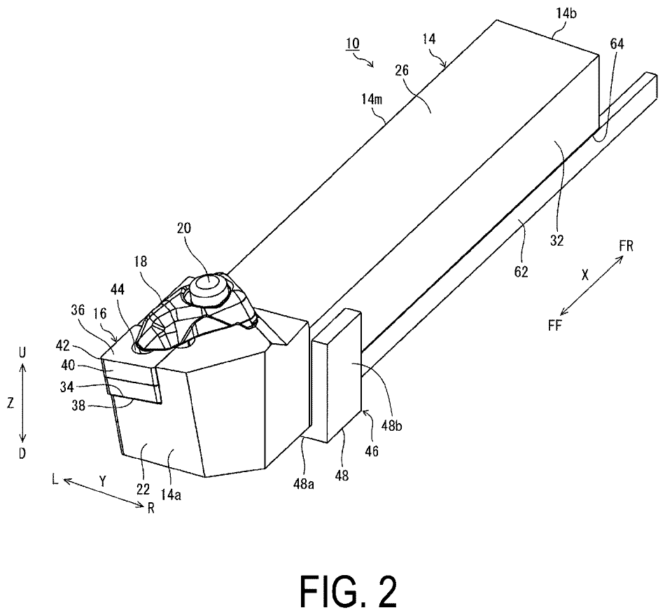

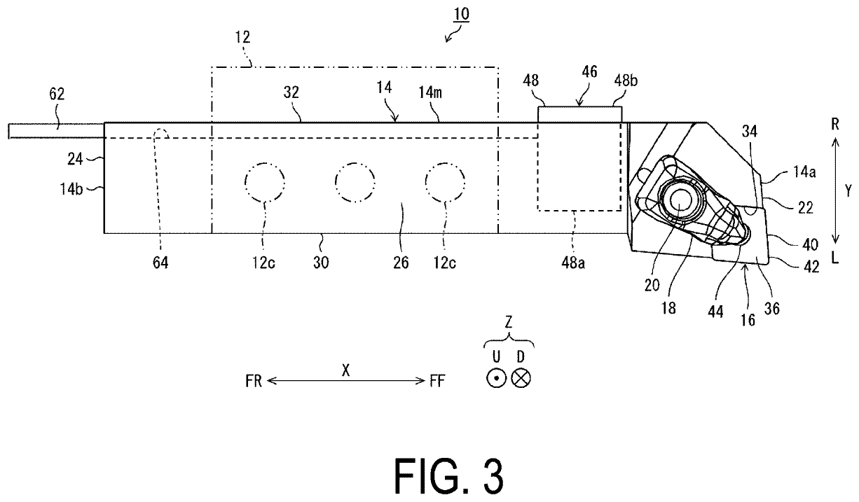

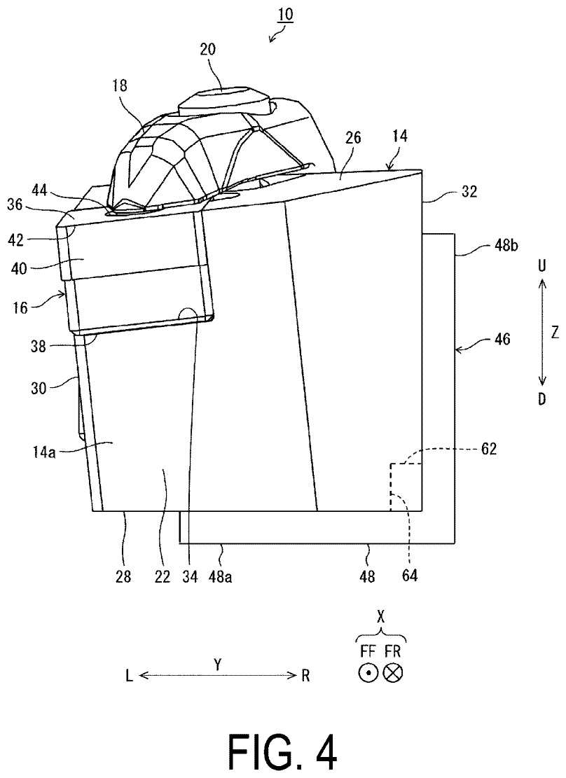

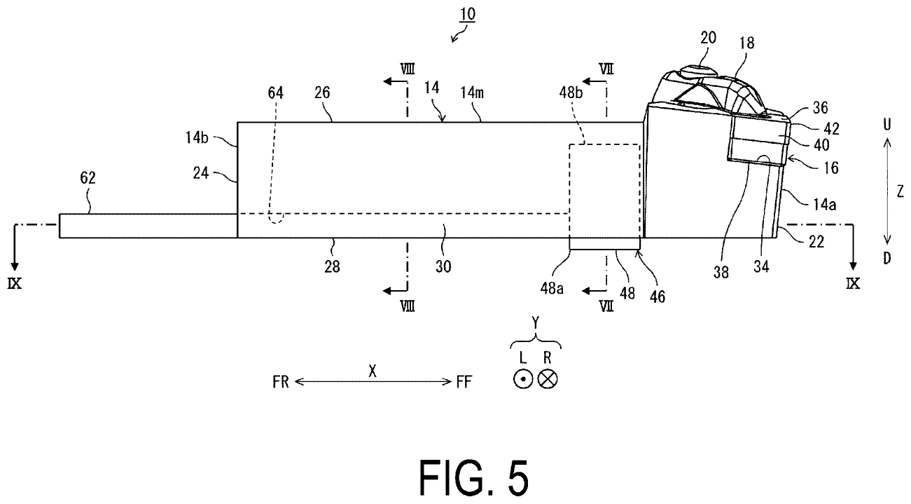

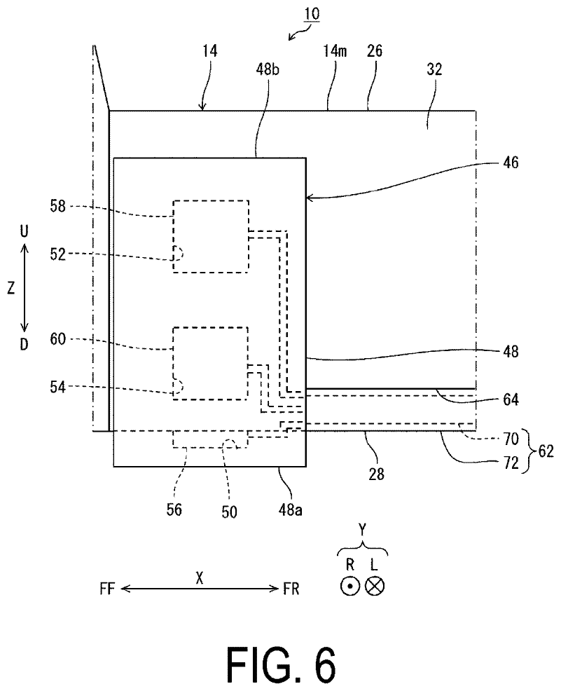

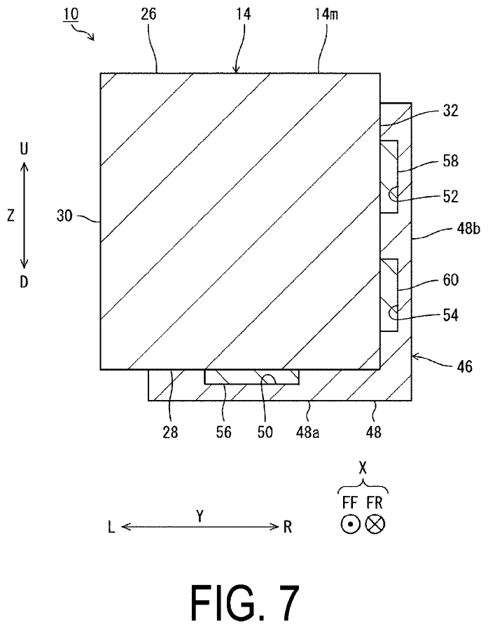

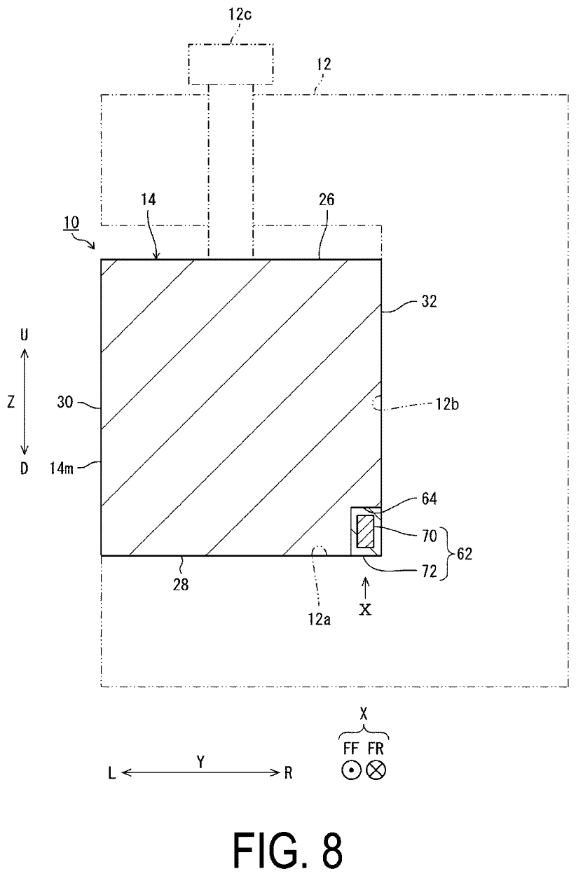

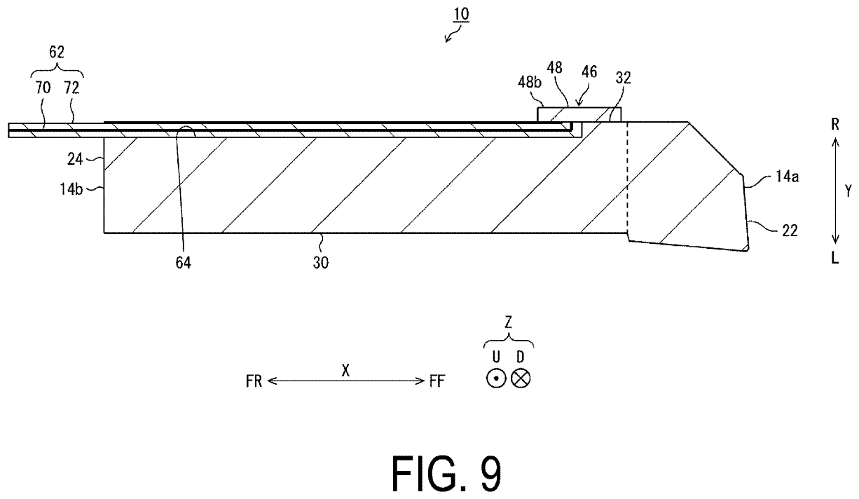

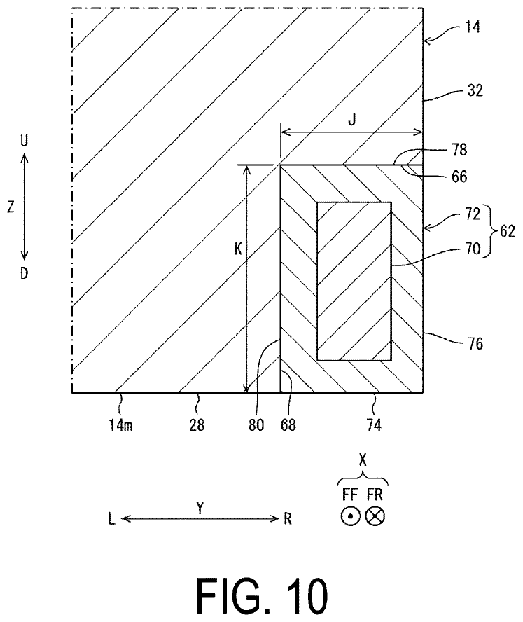

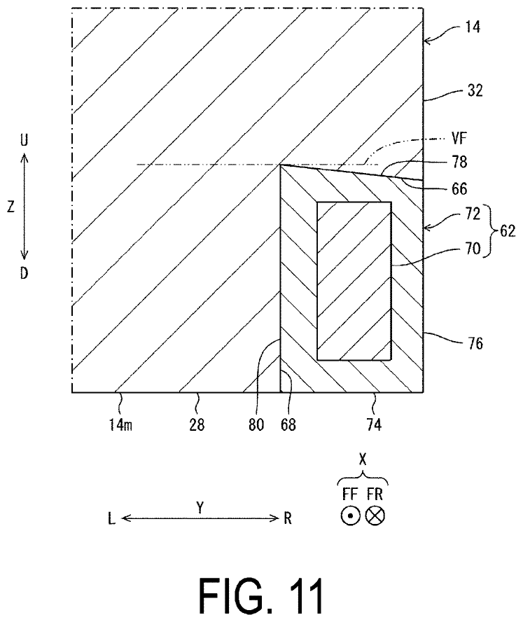

A cutting tool 10 according to an embodiment of the present disclosure will be described with reference to FIGS. 1 to 13. FIG. 1 is a schematic perspective view of the cutting tool 10 according to the embodiment of the present disclosure. FIG. 2 is a schematic perspective view of the cutting tool illustrated in FIG. 1 viewed at a different angle. FIG. 3 is a schematic plan view of the cutting tool 10 illustrated in FIG. 1. FIG. 4 is a schematic view of the cutting tool 10 illustrated in FIG. 1 viewed from the front end side thereof. FIG. 5 is a schematic side view of the cutting tool 10 illustrated in FIG. 1. FIG. 6 is an enlarged side view of the vicinity of a sensor unit when viewed from the opposite side of FIG. 5. FIG. 7 is a cross-sectional view taken along line VII-VII in FIG. 5. FIG. 8 is a cross-sectional view taken along line VIII-VIII in FIG. 5. FIG. 9 is a cross-sectional view taken along line IX-IX in FIG. 5. FIG. 10 is an enlarged view of a portion X in FIG. 8, and is an enlarged cross-sectional view illustrating a groove of a holder and a wiring member. FIGS. 11 to 13 are enlarged cross-sectional views illustrating a groove of a holder and a wiring member in a cutting tool according to another aspect of the embodiment of the present disclosure.

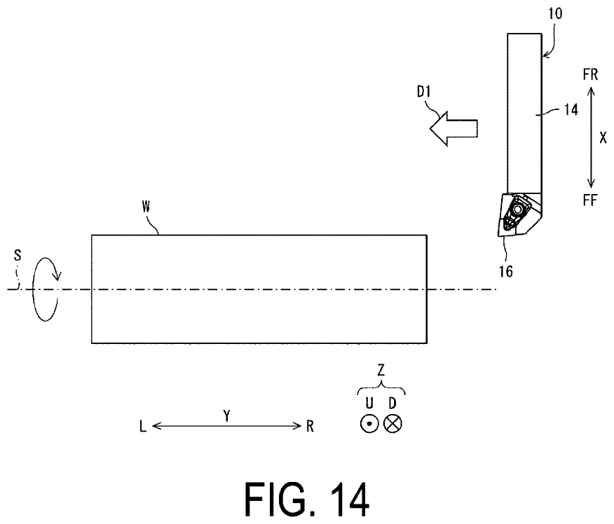

As the example illustrated in FIGS. 1 to 3, the cutting tool 10 according to the embodiment of the present disclosure is a tool used for machining of a workpiece W (see FIG. 14). The machining of the workpiece W includes external turning, boring, groove-forming, and cutting-off. The cutting tool 10 may include a holder 14 mounted on a cutting implement rest 12 of a lathe, a cutting insert 16 held by the holder 14, a clamp 18 fixing the cutting insert 16 to the holder 14, and a clamping screw 20 for attaching the clamp 18 to the holder 14.

As in the example illustrated in FIGS. 1 to 3, the holder 14 may have a rod shape extending along the X direction from the front end 14a toward the rear end 14b. The longitudinal direction of the holder 14 may be the X direction. The holder 14 may include a quadrangular prism-shaped body portion 14m located closer to the rear end 14b side than the clamp 18.

As an example illustrated in FIGS. 1 to 5, the holder 14 may include a front end surface 22 located on the front end 14a side and a rear end surface 24 located on the opposite side to the front end surface 22. The holder 14 may include an upper surface 26 extending in the X direction from the front end surface 22 toward the rear end 14b to the rear end surface 24. The holder 14 may include a lower surface 28 located on the opposite side to the upper surface 26, and the lower surface 28 may extend in the X direction from the front end surface 22 toward the rear end 14b to the rear end surface 24.

The holder 14 may include a first side surface 30 located between the upper surface 26 and the lower surface 28, and the first side surface 30 may extend in the X direction from the front end surface 22 toward the rear end 14b to the rear end surface 24. The first side surface 30 of the holder 14 may be connected to the upper surface 26 and the lower surface 28. In the body portion 14m of the holder 14, the first side surface 30 may be orthogonal to the lower surface 28 and the upper surface 26.

The holder 14 may include a second side surface 32 located on the opposite side to the first side surface 30, and the second side surface 32 may extend in the X direction from the front end surface 22 toward the rear end 14b to the rear end surface 24. The second side surface 32 may be connected to the upper surface 26 and the lower surface 28. In the body portion 14m, the second side surface 32 may be orthogonal to the lower surface 28 and the upper surface 26.

The front end surface 22, the rear end surface 24, the upper surface 26, the lower surface 28, the first side surface 30, and the second side surface 32 of the holder 14 may constitute outer surfaces of the holder 14. The holder 14 may include a pocket 34 for holding the cutting insert 16 on the front end 14a side. The pocket 34 may be open to the front end surface 22, the upper surface 26, and the first side surface 30.

When the cutting tool 10 is mounted on the cutting implement rest 12, the lower surface 28 of the body portion 14m of the holder 14 is supported by a placement surface 12a (see FIG. 8) of the cutting implement rest 12. The second side surface 32 of the body portion 14m of the holder 14 is supported by an inner wall surface 12b (see FIG. 8) of the cutting implement rest 12. The upper surface 26 of the body portion 14m of the holder 14 is pressed by a fixing screw 12c (see FIG. 8) of the cutting implement rest 12.

Examples of the material of the holder 14 include metals such as stainless steel, carbon steel, cast iron, and an aluminum alloy. The length of the holder 14 may be set to, for example, from 100 mm to 400 mm.

As in the examples illustrated in FIG. 1 to FIG. 5, the cutting insert 16 may be located in the pocket 34 of the holder 14. The cutting insert 16 may be a replaceable insert called a throw-away insert. The cutting insert 16 may have a quadrangular plate shape, or may have a triangular plate shape or a pentagonal plate shape other than the quadrangular plate shape. The cutting insert 16 may include a first insert surface 36, a second insert surface 38 located on the opposite side to the first insert surface 36, and a plurality of insert side surfaces 40 located between the first insert surface 36 and the second insert surface 38.

The cutting insert 16 may include a cutting edge 42 at the intersection of the first insert surface 36 and the insert side surface 40. The first insert surface 36 may function as a rake surface for channeling chips. The insert side surface 40 may function as a flank surface.

The cutting insert 16 may include a through hole 44 that is open to the first insert surface 36 and the second insert surface 38. The cutting insert 16 is attached to the pocket 34 by tightening the clamping screw 20 in a state where the front end portion of the clamp 18 is engaged with the through hole 44.

Examples of the material of the cutting insert 16 include a cemented carbide alloy and a cermet. Examples of the composition of the cemented carbide alloy include WC-Co, WC-TiC-Co, and WC-TiC-TaC-Co. WC-Co is produced by adding a cobalt (Co) powder to tungsten carbide (WC) and sintering them. WC-TiC-Co is formed by adding titanium carbide (TiC) to WC-Co. WC-TiC-TaC-Co is formed by adding tantalum carbide (TaC) to WC-TiC-Co. Cermet is a sintered composite material in which a metal is combined with a ceramic component. Specifically, examples of the cermet include compounds in which a titanium compound such as titanium carbide (TiC) or titanium nitride (TiN) is the primary component.

The surface of the cutting insert 16 may be coated with a coating film using a chemical vapor deposition (CVD) method or a physical vapor deposition (PVD) method. Examples of the material of the coating film include titanium carbide (TiC), titanium nitride (TiN), titanium carbonitride (TiCN), and alumina (Al₂O₃).

As in the examples illustrated in FIGS. 2 to 7, the cutting tool 10 may include a sensor unit 46 for detecting a physical quantity such as the acceleration, vibration, strain, or internal stress of the holder 14 (cutting tool 10). The sensor unit 46 may be located from the lower surface 28 of the body portion 14m to the second side surface 32 on the front end 14a side of the holder 14. A unit base 48 may be attached to the body portion 14m of the holder 14 by an adhesive. The unit base 48 may be attached to the body portion 14m of the holder 14 by magnetic force of a built-in magnet. The unit base 48 may be attached to the body portion 14m of the holder 14 by a fixing member such as a screw. Examples of the material of the unit base 48 include synthetic resin and metal.

As in the example illustrated in FIGS. 4 and 7, the unit base 48 may have an L shape in a cross section orthogonal to the X direction which is the longitudinal direction of the holder 14. The unit base 48 may include a first portion 48a located on the lower surface 28 of the holder 14 and a second portion 48b located on the second side surface 32 of the holder 14.

As in the example illustrated in FIGS. 6 and 7, the first portion 48a of the unit base 48 may include a first recessed portion 50 that is open toward the lower surface 28 of the holder 14. The first recessed portion 50 of the unit base 48 may be a bottomed hole (depression) or a through hole. The second portion 48b of the unit base 48 may include a second recessed portion 52 that is open toward the second side surface 32 of the holder 14. The second recessed portion 52 of the unit base 48 may be a bottomed hole or a through hole. The second portion 48b of the unit base 48 may include a third recessed portion 54 that is open toward the second side surface 32 of the holder 14. The third recessed portion 54 of the unit base 48 may be a bottomed hole or a through hole. The third recessed portion 54 of the unit base 48 may be continuous with the second recessed portion 52.

The sensor unit 46 may include a first sensor 56 located within the first recessed portion 50 of the unit base 48. The first sensor 56 may be fixed in the first recessed portion 50 of the unit base 48 by an adhesive or the like. The first sensor 56 may come into contact with the lower surface 28 of the holder 14. The first sensor 56 may be located on the lower surface 28, which is the outer surface, on the front end 14a side of the holder 14. The first sensor 56 may detect any one or more of physical quantities such as the acceleration, vibration, strain, and internal stress of the holder 14. The detection direction of the first sensor 56 may be the Y direction. In other words, the first sensor 56 may detect a physical quantity such as the acceleration, vibration, strain, or internal stress of the holder 14 in the Y direction. The first sensor 56 may detect the acceleration or the like of the holder 14 corresponding to a feed component force which is one of cutting loads.

The sensor unit 46 may include a second sensor 58 located in the second recessed portion 52 of the unit base 48. The second sensor 58 may be fixed in the second recessed portion 52 of the unit base 48 by an adhesive or the like. The second sensor 58 may come into contact with the second side surface 32 of the holder 14. The second sensor 58 may be located on the second side surface 32 which is the outer surface on the front end 14a side of the holder 14. The second sensor 58 may detect any one or more of physical quantities such as the acceleration, vibration, strain, and internal stress of the holder 14. The second sensor 58 may detect the same physical quantity as the first sensor 56. The detection direction of the second sensor 58 may be the X-direction orthogonal to the detection direction of the first sensor 56. In other words, the second sensor 58 may detect a physical quantity such as the acceleration, vibration, strain, or internal stress of the holder 14 in the X direction. The second sensor 58 may detect the acceleration or the like of the holder 14 corresponding to a thrust component force which is a cutting load.

The sensor unit 46 may include a third sensor 60 located in the third recessed portion 54 of the unit base 48. The third sensor 60 may be fixed in the third recessed portion 54 of the unit base 48 by an adhesive or the like. The third sensor 60 may come into contact with the second side surface 32 of the holder 14. The third sensor 60 may be located on the second side surface 32 on the front end 14a side of the holder 14. The third sensor 60 may detect any one or more of physical quantities such as the acceleration, vibration, strain, and internal stress of the holder 14. The third sensor 60 may detect the same physical quantity as the first sensor 56 and the second sensor 58. The detection direction of the third sensor 60 may be the Z direction orthogonal to the detection directions of the first sensor 56 and the second sensor 58. In other words, the third sensor 60 may detect a physical quantity such as the acceleration, vibration, strain, or internal stress of the holder 14 in the Z direction. The third sensor 60 may detect the acceleration or the like of the holder 14 corresponding to a main component force which is one of the cutting loads.

The first sensor 56, the second sensor 58, and the third sensor 60 may detect physical quantities such as the acceleration, vibration, strain, and internal stress of the holder 14 in the XYZ direction. The first sensor 56, the second sensor 58, and the third sensor 60 may detect the acceleration or the like of the holder 14 corresponding to cutting loads in three directions (main component force, thrust component force, and feed component force).

The positions of the first sensor 56, the second sensor 58, and the third sensor 60 in the X direction may be the same. The first sensor 56, the second sensor 58, and the third sensor 60 may be electrostatic capacitance detection sensors or piezoresistive sensors. The first sensor 56, the second sensor 58, and the third sensor 60 are the electrostatic capacitance detection sensors, the sensors may be Micro Electro Mechanical Systems (MEMS).

The detection direction of the first sensor 56 may be changed from the Y direction to the XY direction. The first sensor 56 may detect a physical quantity such as the acceleration, vibration, strain, or internal stress of the holder 14 in the XY direction. The first sensor 56 may detect the acceleration or the like of the holder 14 corresponding to the feed component force and the main component force. In these cases, one of the second sensor 58 and the third sensor 60 may be omitted from the components of the sensor unit 46. The first sensor 56 and the second sensor 58, or the first sensor 56 and the third sensor 60 may detect a physical quantity such as the acceleration, vibration, strain, or internal stress of the holder 14 in the XYZ direction. The first sensor 56 and the second sensor 58, or the first sensor 56 and the third sensor 60 may detect the acceleration or the like of the holder 14 corresponding to cutting loads in three directions.

The detection direction of the second sensor 58 may be changed from the X direction to the XZ direction. The second sensor 58 may detect a physical quantity such as the acceleration, vibration, strain, or internal stress of the holder 14 in the XZ direction. The second sensor 58 may detect the acceleration or the like of the holder 14 corresponding to the thrust component force and the main component force. In this case, the third sensor 60 may be omitted from the components of the sensor unit 46. The first sensor 56 and the second sensor 58 may detect a physical quantity such as the acceleration, vibration, strain, or internal stress of the holder 14 in the XYZ direction. The first sensor 56 and the second sensor 58 may detect the acceleration or the like of the holder 14 corresponding to cutting loads in three directions.

The detection direction of the third sensor 60 may be changed from the Z direction to the XZ direction. The third sensor 60 may detect a physical quantity such as the acceleration, vibration, strain, or internal stress of the holder 14 in the XZ direction. The third sensor 60 may detect the acceleration or the like of the holder 14 corresponding to the main component force and the thrust component force. In this case, the second sensor 58 may be omitted from the components of the sensor unit 46. The first sensor 56 and the third sensor 60 may detect a physical quantity such as the acceleration, vibration, strain, or internal stress of the holder 14 in the XYZ direction. The first sensor 56 and the third sensor 60 may detect the acceleration or the like of the holder 14 corresponding to cutting loads in three directions.

As in the examples illustrated in FIGS. 2, 5, 6, 8, and 9, the cutting tool 10 may include a wiring member 62 electrically connected to the first sensor 56, the second sensor 58, and the third sensor 60. The wiring member 62 may extend in the X direction from the side of the first sensor 56 or the like toward the rear end 14b of the holder 14.

As in the examples illustrated in FIGS. 2, 5, 6, and 9 to 13, the holder 14 may include a groove 64 that is open to both the lower surface 28 and the second side surface 32. When the groove 64 opens to both the lower surface 28 and the second side surface 32, the groove 64 is easily formed compared to when the groove 64 is open to only one of the lower surface 28 and the second side surface 32. When the wiring member 62 is located in the groove 64 as will be described later, the wiring member 62 is easily attached. The groove 64 of the holder 14 may be open to the rear end surface 24. The groove 64 of the holder 14 may extend in the X direction from the front end 14a side toward the rear end 14b. The groove 64 of the holder 14 may include a first bearing surface 66 connected to the second side surface 32 and a second bearing surface 68 connected to the lower surface 28.

As in the example illustrated in FIG. 10, in the cross section orthogonal to the X direction which is the longitudinal direction of the holder 14, a width J of the groove 64 in the direction parallel to the second side surface 32 may be larger than a width K of the groove in the direction parallel to the lower surface 28. As in the example illustrated in FIGS. 2 and 3, the groove 64 of the holder 14 may be located closer to the rear end 14b of the holder 14 than the pocket 34. The groove 64 of the holder 14 may be located closer to the second side surface 32 than the pocket 34.

As in the example illustrated in FIGS. 2, 6, and 9 to 13, the wiring member 62 may be located in the groove 64 of the holder 14. In other words, the groove 64 of the holder 14 may accommodate the wiring member 62. The wiring member 62 may be electrically connected to the first sensor 56, the second sensor 58, and the third sensor 60. The wiring member 62 may extend in the X direction from the side of the first sensor 56 or the like toward the rear end 14b of the holder 14.

As in the examples illustrated in FIGS. 9 to 13, the wiring member 62 may include a wiring conductor 70 electrically connected to the first sensor 56, the second sensor 58, and the third sensor 60. The wiring conductor 70 may extend in the X direction from the side of the first sensor 56 or the like toward the rear end 14b of the holder 14.

The wiring member 62 may include a tubular holding member 72 that holds the wiring conductor 70. The holding member 72 may be located in the groove 64 of the holder 14. In other words, the groove 64 of the holder 14 may accommodate the holding member 72. The holding member 72 may extend in the X direction from the front end 14a side of the holder 14 toward the rear end 14b. The material of the holding member 72 may be the same as that of the holder 14. When the material of the holding member 72 is metal, the holding member 72 may be divided along the X direction. The material of the holding member 72 may be a synthetic resin, and the holding member 72 may be an extrusion molded product.

As in the example illustrated in FIGS. 10 to 13, the holding member 72 may include a first end surface 74 located on the lower surface 28 side of the holder 14 and a second end surface 76 located on the second side surface 32 side of the holder 14. The distance in the Z direction from the upper surface 26 of the holder 14 to the first end surface 74 of the holding member 72 may be equal to or less than the distance in the Z direction from the upper surface 26 to the lower surface 28 of the holder 14. The distance in the Y direction from the first side surface 30 of the holder 14 to the second end surface 76 of the holding member 72 may be equal to or less than the distance in the Y direction from the first side surface 30 to the second side surface 32 of the holder 14.

The holding member 72 may include a first contact surface 78 located on the opposite side to the first end surface 74, and the first contact surface 78 may come into contact with the first bearing surface 66 of the groove 64 of the holder 14. The holding member 72 may include a second contact surface 80 located on the opposite side to the second end surface 76, and the second contact surface 80 may come into contact with the second bearing surface 68 of the groove 64 of the holder 14.

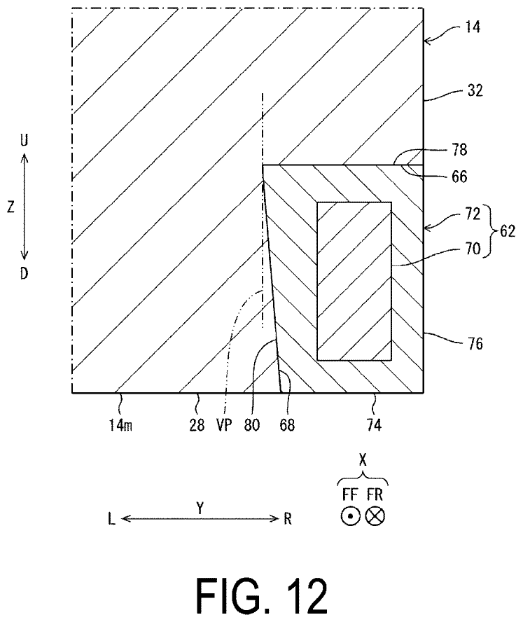

As in the example illustrated in FIG. 11, each of the first contact surface 78 of the holding member 72 and the first bearing surface 66 of the groove 64 of the holder 14 may be inclined with respect to a virtual plane VF parallel to the lower surface 28 to be farther away from the lower surface 28 as being farther apart from the second side surface 32 of the holder 14. As in the example illustrated in FIG. 12, the second contact surface 80 of the holding member 72 and the second bearing surface 68 of the groove 64 of the holder 14 may be inclined with respect to a virtual plane VP orthogonal to the lower surface 28 to be farther away from the second side surface 32 as being farther apart from the lower surface 28 of the holder 14.

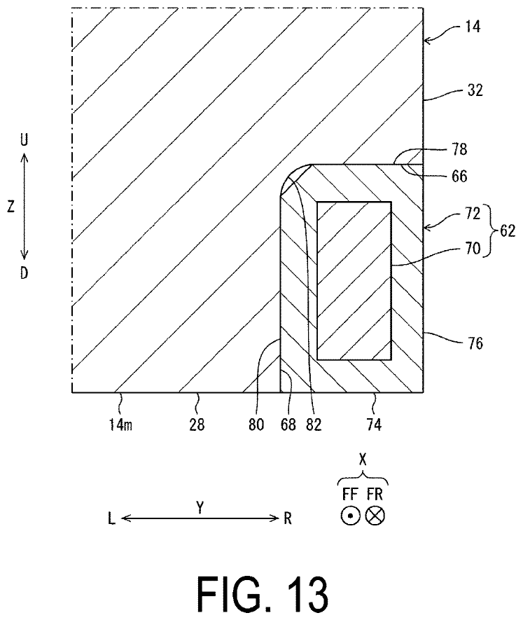

As in the example illustrated in FIG. 13, the first bearing surface 66 and the second bearing surface 68 of the groove 64 of the holder 14 may each be a flat surface. The groove 64 of the holder 14 may further include a connecting surface 82 having a recessed curved shape and located between the first bearing surface 66 and the second bearing surface 68. The wiring member 62 may be separated from the connecting surface 82 of the groove 64 of the holder 14.

The wiring member 62 may be electrically connected to an information processing device installed outside a machine tool or the like. The information processing device may be configured by a computer, and may include a memory that stores various control programs and the like and a central processing unit (CPU) that interprets and executes the control programs.

When the control program is executed by the CPU, the information processing device exhibits various functions. In one aspect, the information processing device may adjust the moving speed of the cutting tool 10 based on the physical quantities of the holder 14 detected by the first sensor 56, the second sensor 58, and the third sensor 60. In one aspect, the information processing device may adjust the rotational speed of the workpiece W based on the physical quantities of the holder 14 detected by the first sensor 56, the second sensor 58, and the third sensor 60.

According to an example of the embodiment of the present disclosure, the groove 64 of the holder 14 is open to both the lower surface 28 and the second side surface 32, and extends in the X direction from the side of the first sensor 56 or the like toward the rear end 14b of the holder 14. Therefore, the groove 64 can be easily machined in the holder 14 by using a milling tool such as an end mill having a width larger than the groove width of the groove 64. Thus, according to an example of the embodiment of the present disclosure, even when the cutting tool 10 includes the sensor unit 46, the likelihood of an increase in the manufacturing cost of the cutting tool 10 can be reduced. When the groove 64 of the holder 14 is open to one of the lower surface 28 and the second side surface 32, the groove 64 needs to be machined in the holder 14 using a small-diameter milling tool having a shape corresponding to the groove width of the groove 64.

When the wiring member 62 includes the tubular holding member 72, the play of the wiring member 62 in the groove 64 of the holder 14 can be reduced. Thus, according to an example of the embodiment of the present disclosure, damage to the wiring member 62 can be avoided.

According to an example of the embodiment of the present disclosure, as described above, the distance in the Z direction from the upper surface 26 of the holder 14 to the first end surface 74 of the holding member 72 is equal to or less than the distance in the Z direction from the upper surface 26 to the lower surface 28 of the holder 14. The distance in the Y direction from the first side surface 30 of the holder 14 to the second end surface 76 of the holding member 72 is equal to or less than the distance in the Y direction from the first side surface 30 to the second side surface 32 of the holder 14. In such a case, the wiring member 62 is unlikely to protrude from the outer surface of the holder 14. Thus, according to an example of the embodiment of the present disclosure, the cutting tool 10 is easily stably fixed to the cutting implement rest 12.

As in the example illustrated in FIG. 11, when the first contact surface 78 of the holding member 72 and the first bearing surface 66 of the groove 64 of the holder 14 are each inclined with respect to the virtual plane VF, the wiring member 62 is unlikely to protrude from the outer surface of the holder 14. Thus, according to an example of the embodiment of the present disclosure, the cutting tool 10 is easily stably fixed to the cutting implement rest 12.

As in the example illustrated in FIG. 12, when the second contact surface 80 of the holding member 72 and the second bearing surface 68 of the groove 64 of the holder 14 are each inclined with respect to the virtual plane VP, the wiring member 62 is unlikely to protrude from the outer surface of the holder 14. Thus, according to an example of the embodiment of the present disclosure, the cutting tool 10 is easily stably fixed to the cutting implement rest 12.

As in the example illustrated in FIGS. 10 to 13, when the first contact surface 78 and the second contact surface 80 of the holding member 72 respectively come into contact with the first bearing surface 66 and the second bearing surface 68 of the groove 64 of the holder 14, positioning of the wiring member 62 with respect to the holder 14 is facilitated. Thus, according to an example of the embodiment of the present disclosure, attachment of the cutting tool 10 to the cutting implement rest 12 is simplified.

As in the example illustrated in FIG. 10, in the cross section orthogonal to the X direction, when the width K of the groove 64 in the direction parallel to the second side surface 32 is larger than the width J of the groove in the direction parallel to the lower surface 28, the rigidity of the holder 14 is likely to be ensured even when the groove 64 is machined in the holder 14. Thus, according to an example of the embodiment of the present disclosure, the durability of the cutting tool 10 can be improved even when the cutting tool 10 is provided with the sensor unit 46.

As in the example illustrated in FIGS. 2 and 3, when the groove 64 of the holder 14 is located closer to the rear end 14b of the holder 14 than the pocket 34, the main component force is less likely to be transmitted to the groove 64 of the holder 14. Therefore, concentration of stress on the boundary between the first bearing surface 66 and the second bearing surface 68 in the groove 64 of the holder 14 is avoided, and thus deformation of the boundary is reduced. Cracks are less likely to occur at the boundary. Thus, according to an example of the embodiment of the present disclosure, the durability of the cutting tool 10 can be improved even when the cutting tool 10 is provided with the sensor unit 46.

As in the example illustrated in FIGS. 2 and 3, when the groove 64 of the holder 14 is located closer to the second side surface 32 than the pocket 34, the main component force is less likely to be transmitted to the groove 64 of the holder 14. Therefore, concentration of stress on the boundary between the first bearing surface 66 and the second bearing surface 68 in the groove 64 of the holder 14 is avoided, and thus deformation of the boundary is reduced. Cracks are less likely to occur at the boundary. Thus, according to an example of the embodiment of the present disclosure, the durability of the cutting tool 10 can be improved even when the cutting tool 10 is provided with the sensor unit 46.

As in the example illustrated in FIG. 13, when the connecting surface 82 having a recessed curved shape is located between the first bearing surface 66 and the second bearing surface 68 in the groove 64 of the holder 14, stress concentration on the connecting surface 82 which is the boundary between the first bearing surface 66 and the second bearing surface 68 in the groove 64 of the holder 14 is avoided, and thus deformation of this boundary is reduced. Cracks are less likely to occur at the boundary. Thus, according to an example of the embodiment of the present disclosure, the durability of the cutting tool 10 can be improved even when the cutting tool 10 is provided with the sensor unit 46.

In particular, when the wiring member 62 is separated from the connecting surface 82 of the groove 64 of the holder 14, even if stress is concentrated on the connecting surface 82, the connecting surface 82 can be intentionally slightly deformed, and thus cracks are less likely to occur in the connecting surface 82 of the holder 14. Thus, according to an example of the embodiment of the present disclosure, the durability of the cutting tool 10 can be further improved even when the cutting tool 10 is provided with the sensor unit 46.

When the groove 64 of the holder 14 is open to the rear end surface 24, the wiring member 62 can be pulled out from the rear end 14b of the holder 14. Therefore, according to an example of the embodiment of the present disclosure, the wiring member 62 is less likely to be an obstacle, and the cutting tool 10 is easily attached to the cutting implement rest 12.

### Method for Manufacturing Machined Product

A description will be given of a method for manufacturing a machined product according to an embodiment of the present disclosure with reference to FIGS. 14 to 16. FIGS. 14 to 16 are schematic views illustrating the method for manufacturing the machined product according to the embodiment of the present disclosure.

As in the example illustrated in FIGS. 14 to 16, the method for manufacturing the machined product according to the embodiment of the present disclosure is a method for manufacturing a machined product M, which is the workpiece W after machined, and includes a first step, a second step, and a third step. The first step is a step of rotating the workpiece W about its axis S. The second step is a step of bringing the cutting insert 16 of the cutting tool 10 into contact with the rotating workpiece W and cutting the workpiece W. The third step is a step of separating the cutting tool 10 from the cut workpiece W. Examples of the material of the workpiece W include stainless steel, carbon steel, alloy steel, cast iron, and a non-ferrous metal. The specific content of the method for manufacturing the machined product according to the embodiment is as follows.

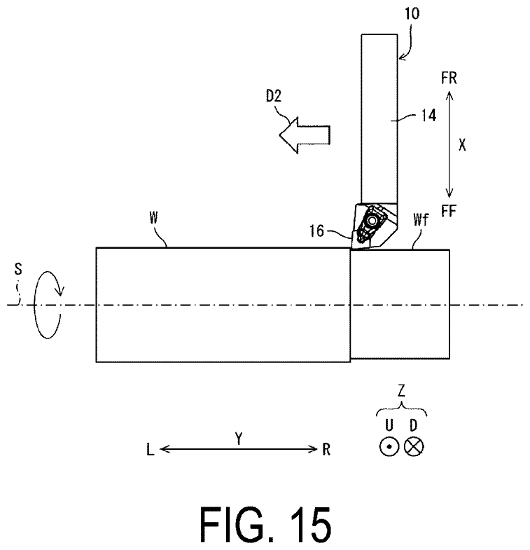

First, the cutting tool 10 is attached to the cutting implement rest 12, and the workpiece W is mounted to a chuck of a lathe. Then, as in the example illustrated in FIG. 14, the chuck is rotated to rotate the workpiece W about its axis S (first step). As in the example illustrated in FIG. 15, the cutting tool 10 is moved in the direction of an arrow DI to approach the workpiece W, and the cutting insert 16 is brought into contact with the rotating workpiece W and the workpiece W is cut (second step). Thus, a machined surface Wf can be formed on the workpiece W.

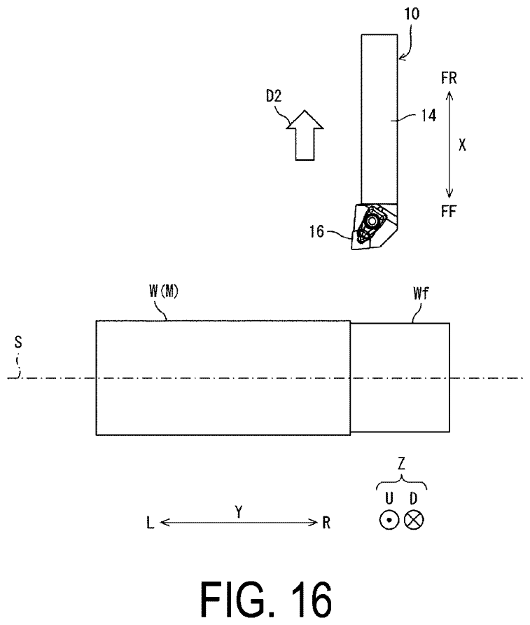

Then, as in the example illustrated in FIG. 16, the cutting tool 10 is moved in the direction of an arrow D2, whereby the cutting tool 10 is moved away from the workpiece W (third step). This completes the machining of the workpiece W and enables the machined product M, which is the workpiece W after the machining, to be manufactured. Since the cutting tool 10 has excellent cutting capabilities because of the above reasons, the machined product M having an excellent machining accuracy can be manufactured.

When the machining is continued, the cutting insert 16 may be repeatedly brought into contact with a different portion of the workpiece W, while the workpiece W is rotated. Although the cutting tool 10 is brought close to the workpiece W in the embodiment of the present disclosure, the cutting tool 10 only needs to be brought relatively close to the workpiece W. Accordingly, the workpiece W may be brought close to the cutting tool 10. In this respect, the same procedure is performed in separating the cutting tool 10 from the workpiece W.

In an embodiment, (1) a cutting tool includes a holder having a rod shape extending from a front end toward a rear end and including a front end surface located on a side of the front end, an upper surface extending from the front end surface toward the rear end, a lower surface located on an opposite side to the upper surface, a first side surface located between the upper surface and the lower surface and extending from the front end surface toward the rear end, a second side surface located on an opposite side to the first side surface, and a pocket open to the front end surface, the upper surface, and the first side surface, a cutting insert located in the pocket and including a cutting edge, a sensor located on an outer surface of the holder on a side of the front end and configured to detect a physical quantity of the holder, and a wiring member electrically connected to the sensor and extending from a side of the sensor toward the rear end, wherein the holder further includes a groove open to both the lower surface and the second side surface and extending from the side of the front end toward the rear end, and the wiring member is located in the groove.

(2) In the cutting tool according to (1), the wiring member may include a wiring conductor electrically connected to the sensor and extending from the side of the sensor toward the rear end, and a holding member having a tubular shape, located in the groove, extending from the side of the front end toward the rear end, and holding the wiring conductor.

(3) In the cutting tool according to (2), the holding member may include a first end surface located on a side of the lower surface, and a second end surface located on a side of the second side surface, a distance from the upper surface to the first end surface is equal to or less than a distance from the upper surface to the lower surface, and a distance from the first side surface to the second end surface is equal to or less than a distance from the first side surface to the second side surface.

(4) In the cutting tool according to (3), the groove may include a first bearing surface connected to the second side surface, and a second bearing surface connected to the lower surface, and the holding member may further include a first contact surface located on an opposite side to the first end surface and in contact with the first bearing surface, and a second contact surface located on an opposite side to the second end surface and in contact with the second bearing surface.

(5) In the cutting tool according to (4), each of the first contact surface and the first bearing surface may be inclined with respect to a virtual plane parallel to the lower surface to be farther away from the lower surface as being farther apart from the second side surface.

(6) In the cutting tool according to (4), each of the second contact surface and the second bearing surface may be inclined with respect to a virtual plane orthogonal to the lower surface to be farther away from the second side surface as being farther apart from the lower surface.

(7) In the cutting tool according to any one of (4) to (6), each of the first bearing surface and the second bearing surface may be a flat surface, and the groove may further include a connecting surface having a recessed curved shape and located between the first bearing surface and the second bearing surface.

(8) In the cutting tool according to (7), the wiring member may be separated from the connecting surface.

(9) In the cutting tool according to any one of (1) to (8), in a cross section orthogonal to a longitudinal direction of the holder, a width of the groove in a direction parallel to the second side surface may be larger than a width of the groove in a direction parallel to the lower surface.

(10) In the cutting tool according to any one of (1) to (9), the groove may be located closer to the rear end than the pocket.

(11) In the cutting tool according to any one of (1) to (10), the groove may be located closer to the second side surface than the pocket.

(12) In the cutting tool according to any one of (1) to (11), the holder may further include a rear end surface located on an opposite side to the front end surface, and the groove may be open to the rear end surface.

(13) A method for manufacturing a machined product includes rotating a workpiece, bringing the cutting tool according to any one of (1) to (12) into contact with the workpiece that is rotating, and cutting the workpiece, and separating the cutting tool from the workpiece that has been cut.

In the present disclosure, the invention has been described above based on the drawings and embodiments. However, the invention according to the present disclosure is not limited to the above-described embodiment. In other words, the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, note that those skilled in the art can easily make various variations or modifications based on the present disclosure. Note that such variations or modifications are included within the scope of the present disclosure.

### REFERENCE SIGNS

10 Cutting tool
12 Cutting implement rest
12a Placement surface
12b Inner wall surface
12c Fixing screw
14 Holder
14a Front end
14b Rear end
14m Body portion
16 Cutting insert
18 Clamp
20 Clamping screw
22 Front end surface
24 Rear end surface
26 Upper surface
28 Lower surface
30 First side surface
32 Second side surface
34 Pocket
36 First insert surface
38 Second insert surface
40 Insert side surface
42 Cutting edge
44 Through hole
46 Sensor unit
48 Unit base
48a First portion
48b Second portion
50 First recessed portion
52 Second recessed portion
54 Third recessed portion
56 First sensor
58 Second sensor
60 Third sensor
62 Wiring member
64 Groove
66 First bearing surface
68 Second bearing surface
70 Wiring conductor
72 Holding member
74 First end surface
76 Second end surface
78 First contact surface
80 Second contact surface
82 Connecting surface

1. A cutting tool comprising:
a holder having a rod shape extending from a front end toward a rear end and comprising:
a front end surface located on a side of the front end;
an upper surface extending from the front end surface toward the rear end;
a lower surface located on an opposite side to the upper surface;
a first side surface located between the upper surface and the lower surface and extending from the front end surface toward the rear end;
a second side surface located on an opposite side to the first side surface; and
a pocket open to the front end surface, the upper surface, and the first side surface;
a cutting insert located in the pocket and comprising a cutting edge;
a sensor located on an outer surface of the holder on a side of the front end and configured to detect a physical quantity of the holder; and
a wiring member electrically connected to the sensor and extending from a side of the sensor toward the rear end, wherein
the holder further comprises a groove open to both the lower surface and the second side surface and extending from the side of the front end toward the rear end, and
the wiring member is located in the groove.

2. The cutting tool according to claim 1, wherein
the wiring member comprises:
a wiring conductor electrically connected to the sensor and extending from the side of the sensor toward the rear end; and
a holding member having a tubular shape, located in the groove, extending from the side of the front end toward the rear end, and holding the wiring conductor.

3. The cutting tool according to claim 2, wherein
the holding member comprises:
a first end surface located on a side of the lower surface; and
a second end surface located on a side of the second side surface,
a distance from the upper surface to the first end surface is equal to or less than a distance from the upper surface to the lower surface, and
a distance from the first side surface to the second end surface is equal to or less than a distance from the first side surface to the second side surface.

4. The cutting tool according to claim 3, wherein
the groove comprises:
a first bearing surface connected to the second side surface; and
a second bearing surface connected to the lower surface, and
the holding member further comprises:
a first contact surface located on an opposite side to the first end surface and in contact with the first bearing surface; and
a second contact surface located on an opposite side to the second end surface and in contact with the second bearing surface.

5. The cutting tool according to claim 4, wherein
each of the first contact surface and the first bearing surface is inclined with respect to a virtual plane parallel to the lower surface to be farther away from the lower surface as being farther apart from the second side surface.

6. The cutting tool according to claim 4, wherein
each of the second contact surface and the second bearing surface is inclined with respect to a virtual plane orthogonal to the lower surface to be farther away from the second side surface as being farther apart from the lower surface.

7. The cutting tool according to claim 4, wherein
each of the first bearing surface and the second bearing surface is a flat surface, and
the groove further comprises a connecting surface having a recessed curved shape and located between the first bearing surface and the second bearing surface.

8. The cutting tool according to claim 7, wherein
the wiring member is separated from the connecting surface.

9. The cutting tool according to claim 1, wherein
in a cross section orthogonal to a longitudinal direction of the holder,
a width of the groove in a direction parallel to the second side surface is larger than a width of the groove in a direction parallel to the lower surface.

10. The cutting tool according to claim 1, wherein
the groove is located closer to the rear end than the pocket.

11. The cutting tool according to claim 1, wherein
the groove is located closer to the second side surface than the pocket.

12. The cutting tool according to claim 1, wherein
the holder further comprises a rear end surface located on an opposite side to the front end surface, and
the groove is open to the rear end surface.

13. A method for manufacturing a machined product, the method comprising:
rotating a workpiece;
bringing the cutting tool according to claim 1 into contact with the workpiece that is rotating, and cutting the workpiece; and
separating the cutting tool from the workpiece that has been cut.
